(19) United States
(12) Patent Application Publication
(10) Pub. No.: US 2002/0065844 A1
(43) Pub. Date: May 30, 2002

(54) Metadata internet platform for enabling customization of tags in digital images

(76) Inventors: Rich Robinson, Santa Clara, CA (US); Eric C. Anderson, San Jose, CA (US)

Correspondence Address: SAWYER LAW GROUP LLP, P.O. Box 51418, Palo Alto, CA, 94303, US

(21) Appl. No.: 09/728,785

(22) Filed: Nov. 30, 2000

(51) Int. Cl. G06F 15/00

(52) U.S. Cl. 707/500

(57) ABSTRACT

A system and method for customizing tags in digital images captured with an image capture device that stores the digital images in image files is disclosed. The method and system include storing a key ID and a definition of one or more custom tags on a server on a network. Thereafter a plurality of image files are received over the network, wherein each of the image files includes image data, the key ID, and the custom tags containing data. The method and system further include automatically recognizing the image files by the key ID and using the stored definition to extract the data from the custom tags to make the data available to a user along with the image data.

### FIELD OF THE INVENTION

The present invention relates to digital image files containing image tags, and more particularly to a metadata Internet platform for enabling customization of the tags within digital images.

### BACKGROUND OF THE INVENTION

One advantage of digital cameras over to digital film based cameras is that digital cameras have the ability to store data along with a captured image that may later be accessed by a viewer. For example, once the digital image has been transferred from the digital camera to a PC and displayed, a user may also view information about the image, such as date and time of capture, the name of the image, and image size, for instance. Typically, the data regarding a captured image is stored in tags within the image file of the captured image. Some digital cameras even allow user to enter a name for the image on the camera, which is then stored and display along with the image.

Although the tags are useful for storing camera and image information, the tags in the image files produced by a particular camera fixed at the time of manufacture, and a user cannot change the use of those tags on the camera. As the proliferation of digital cameras continues, however, more uses for digital cameras are being discovered, requiring that digital cameras become more flexible.

One approach to making digital cameras more flexible has been to design digital cameras that they are controlled by software, rather than hardware, so that the digital camera may be continually updated. A side benefit to this approach is that developers may write software applications that run on these cameras to allow the cameras to perform new functions, including providing new uses for the tags. For example, a software application may be written that accepts positioning data from a GPS unit attached to the camera and stores the GPS data in the tags of captured images.

Although the use of the tags may be altered by software application running on the camera, in order for the data in the tags to be displayed with the images, another application running on a PC or other type of computer where the images are uploaded is required that can recognize the data in the tags. Requiring that the developer write both the camera application and the PC application to create custom tags adds to development costs and is burdensome to the user who must install both programs for each new application desired.

Accordingly, what is needed is improved method and system for allowing customization of tags in digital images. The present invention addresses such a need.

### SUMMARY OF THE INVENTION

The present invention provides a method and system for customizing tags in digital images captured with an image capture device is disclosed. The method and system include storing a key ID and a metadata definition of one or more custom tags on a server on a network. Thereafter a plurality of image files are received over the network, wherein each of the image files includes image data, the key ID, and the custom tags containing data. The method and system further include automatically recognizing the image files by the key ID and using the stored definition to extract the data from the custom tags to make the data available to a user along with the image data.

According to the system and method disclosed herein, software developers may store metadata defining custom tags for different camera applications on the server, such that images uploaded to the gateway server are automatically recognized by the key IDs. Thus, the present invention provides a metadata Internet platform that eliminates the need for developers to write their own web applications to recognize the custom tags in the image files. In addition, the key IDs give the same server the ability to recognize and extract custom data from a plurality of different cameras and camera applications.

### BRIEF DESCRIPTION OF THE DRAWINGS

FIG. 1 is a block diagram illustrating a metadata Internet platform for creating custom image tags in accordance with a preferred embodiment of the present invention.

FIG. 2 is a block diagram illustrating a diagram of one embodiment for an image file.

FIG. 3 is a diagram showing of one embodiment for the image tags.

FIGS. 4A and 4B are flow charts illustrating a process for customizing image tags in digital images using the metadata Internet platform in accordance with a preferred embodiment of the present invention.

### DESCRIPTION OF THE INVENTION

The present invention relates to enabling the customization of tags within digital images captured with an image capture device. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. For example, although the preferred embodiment explained in terms of a digital camera, one of ordinary skill in the art will readily recognize that any portable device capable of capturing images could be used, such as a cellphone or PDA equipped with a lens attachment, for instance. Thus, the present invention is not intended to be limited to the embodiments shown but is to be accorded the widest scope consistent with the principles and features described herein.

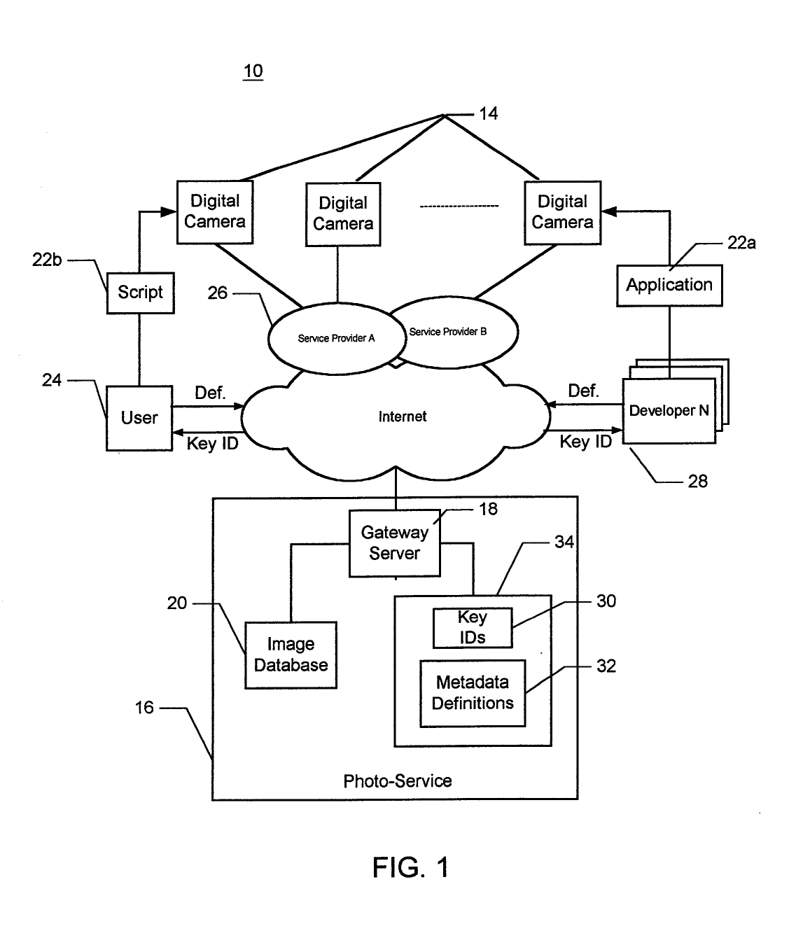

FIG. 1 is a block diagram illustrating a metadata Internet platform for creating custom image tags in accordance with a preferred embodiment of the present invention. The platform 10 includes one or more digital cameras 14 and an online photo-service site 16. The digital cameras 14 capture digital images and store the images on an internal memory, and have the capability of uploading the captured images to the online photo-service site 16 either directly or via a PC. To upload the images directly from the cameras 14, the cameras 14 may be provided with wireless connectivity for connecting to the Internet, although a wired connection method may also be used. In one embodiment, the cameras 14 may connect to the Internet via a service provider 26, which may include a wireless carrier and/or an Internet service provider (ISP).

The online photo-service site 16 includes a gateway server 18 for receiving the images and an image database 20 for storing the images. The photo-service 16 may include other servers besides the gateway server 18, but for simplicity, the function of the other servers will be described as being performed by the gateway server 18. Once uploaded, the images may be stored in the user's account and organized into online web albums. Once the images are stored at the photo-service site 16, the images may be viewed and managed over the Internet by a user through a web browser.

Preferably, the camera 14 includes a microprocessor-based architecture that runs an operating system for controlling the overall functionality of the camera 14 (e.g., taking pictures, storing pictures, and the like). An example of such an operating system 70 is the Digita™ Operating Environment developed by the assignee of the present application. Once an image is captured, the raw image data is processed and stored as an image file in the memory, which may comprise flash memory or other type of non-volatile memory.

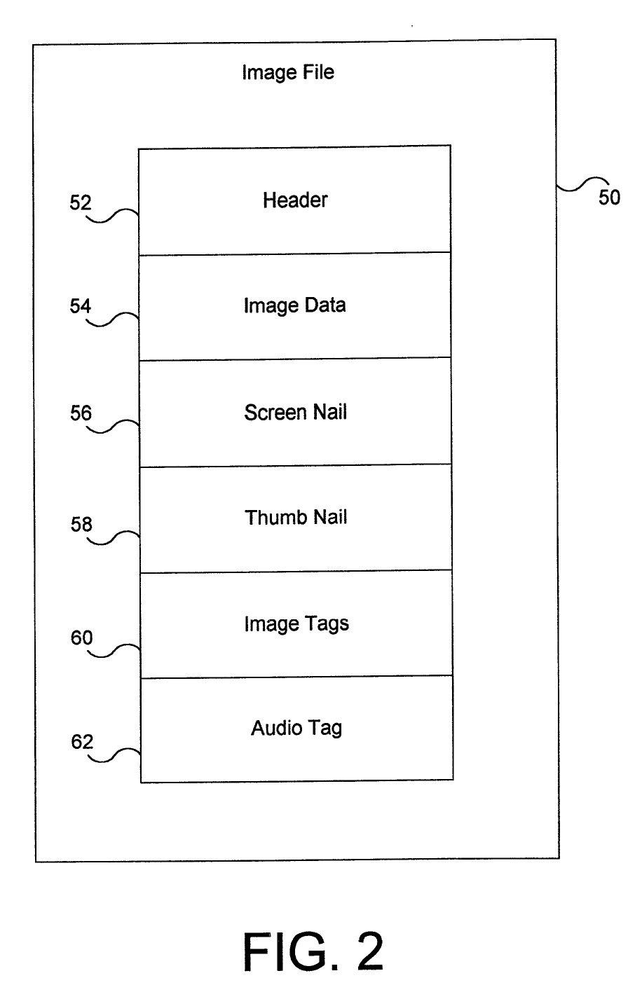

FIG. 2 is a block diagram illustrating a diagram of one embodiment for an image file 50. Image file 50 preferably includes a header 52, image data 54, a screennail 56, a thumbnail 58, image tags 60, and an audio tag 62. Header 52 preferably includes information that identifies and describes the various contents of image file 50. Image data 54 contains actual captured image data, the resolution of which depends on the settings of the camera 14. Image data 54 is typically stored in JPEG format, but may exist in whichever format is appropriate for the current location of image file 50 within the image processing chain of the camera 110. Screennail 56 and thumbnail 58 are each different versions of image data 54 that have varying degrees of reduced resolution for a number of special viewing applications. Image tags 60 store various types of data that correspond and relate to particular captured image data 54. Audio tag 62 stores any sound that has been recorded for the image.

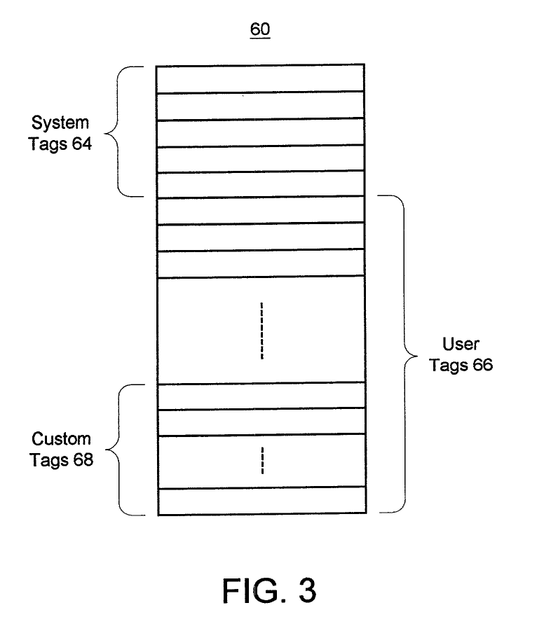

Referring to FIG. 3, a diagram of one embodiment for the image tags 60 is shown. In the FIG. 3 embodiment, image tags 60 include system tags 64, and user tags 66. System tags 64 preferably include various types of camera information that preserve command settings at the moment of capture and correlate with the captured image data 54. For example, system tags 64 may indicate focus setting, aperture setting, and other relevant information that may be used for effectively processing or analyzing the corresponding image data. The data written to the system tags 64 is controlled by the camera 14 and cannot be modified by the user 24.

User tags 66, however, are provided to enable the storage of data that the user 24 enters on the camera 14. For example, a stamp tag may be provided for storing a label a user has entered on the camera to apply to a given image, such as “birthday” or “vacation”. Thus, the function of the stamp tag is to store label data. Although the user 24 may change the data stored in a particular user tag 66, the user 24 may not change the function of that tag 66.

Referring again to FIG. 1, however, the camera 14 has the ability to run software applications 22a and 22b that may be programmed to alter the function of the user tags 66, creating custom tags 68. The term software applications 22 may encompass application programs 22a and scripts 22b. Application programs 22a are stored in the camera 14 as executable files and are typically written by software developers 28. Scripts 22b are text files that are interpreted by the camera 14 and may be written by either the user 24 or developer 28. When the applications 22 are run on the camera 14, the applications 22 may prompt the user 24 to enter data on the camera 14, or may receive data from an external device or a file on the internal flash disk, and insert the data into the image tags 60 during image capture.

In order to create the custom tags 68, however, each developer 28 of a camera application 22 that stores data in the tags 66 must also write a PC or web application that knows what type of data to extract out of which tags and what to do with the data. Because writing custom PC or web applications for each camera application 22 developed for the camera 14 is such a time consuming and expensive task, the widespread adoption of camera applications 22 for software-enabled cameras, is inhibited.

Referring again to FIG. 1, the metadata Internet platform 10 of the present invention provides a method and system for creating custom tags 68 in digital images that eliminates the need for a developer to create a specialized web or PC application to make use of the custom tags 68. According to the present invention, a gateway server 18 allows developers 28 to enter a metadata definition 32 for the custom tags 68 that a particular camera application 22 will use. A key ID 30 is then assigned to that application 22, and the application 22, once run on the camera 14, writes the key ID 30 and data into the custom tags 68 during image capture. When the image files 50 are transferred from the camera 14 to the gateway server 18, the gateway server 18 automatically recognizes the image files 50 by the embedded key IDs 30 and uses the corresponding metadata definition 32 to extract the data from the custom tags 68 and to make the data available for a user 24.

By allowing multiple developers 28 to store metadata 32 defining custom tags 68 for different camera applications 22 on the gateway server 18, such that images uploaded to the gateway server 18 are automatically recognized by the key IDs 30, the metadata Internet platform 10 eliminates the need for developers 28 to write their own web applications to recognize the custom tags 68. In addition, the key IDs 30 give the same gateway server 18 the ability to recognize and extract custom data from a plurality of different cameras 14 and camera applications 22.

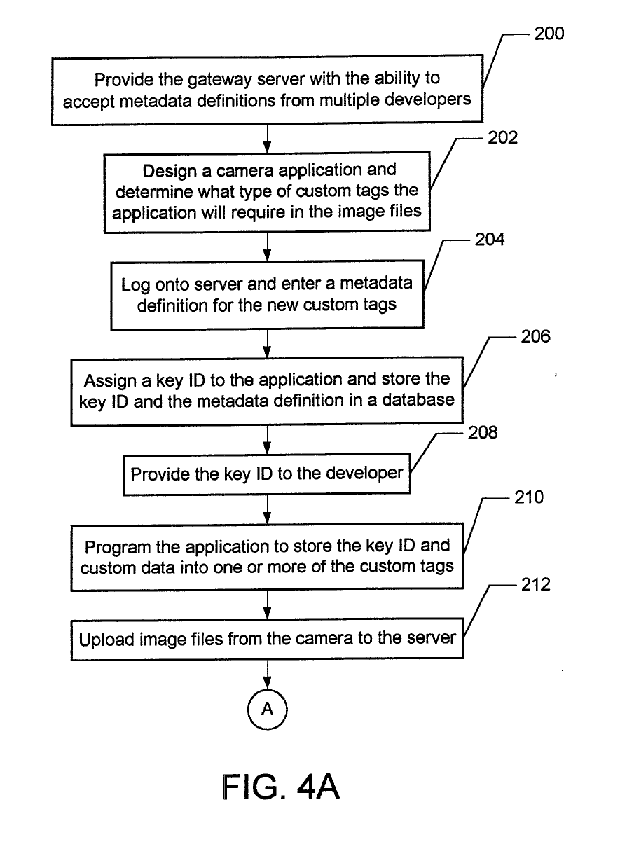

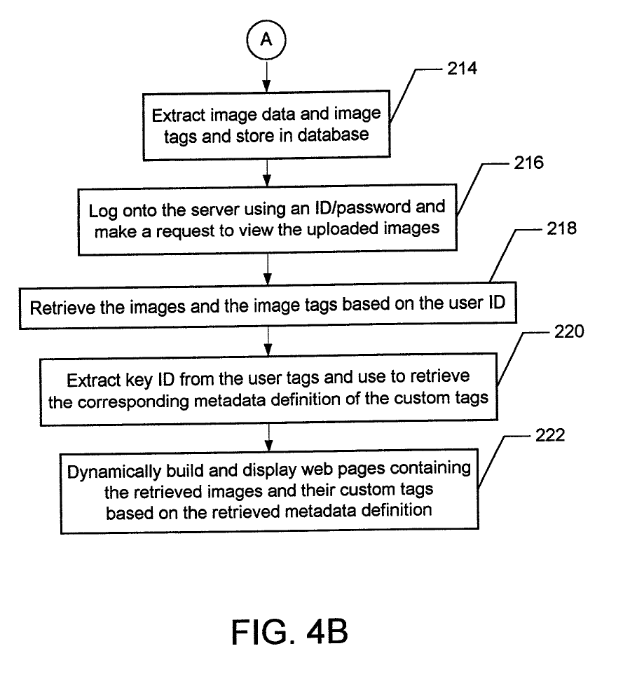

FIGS. 4a and 4b are flow charts illustrating a process for customizing image tags in digital images using the metadata Internet platform 10 in accordance with a preferred embodiment of the present invention. Although the preferred embodiment will be described in terms of a developer 28 developing applications to be run on the camera 14, the term developer includes any entity that writes software to be run on the camera 14, including a user 24, and a camera manufacturer, for instance.

Referring to both FIG. 1 and FIGS. 4a and 4b, the process begins by providing the gateway server 18 with the ability to accept metadata definitions 32 from multiple developers 28 in step 200. Each developer may then design a camera application 22 and determine what type of custom tags 68 the application 22 will require in the image files 50 in step 202.

After determining what type of custom tags 68 are required, the developer logs onto the gateway server 18 and enters a metadata definition 32 for the new custom tags 68 in step 204. The metadata definition 32 entered into web pages instruct the server 18 how to parse and display the data in the custom tags 68 when the server 18 receives image files 50 created by the camera 14 application. The metadata definition 32 entered by the developer may include the name of the tags, their data types, the format for displaying the data in the custom tags 68, and any actions to be taken by the server 18, such as performing calculations on the custom tags 68 or storing the tags 68 in a corporate database, for instance.

After the developer 28 has finished entering the metadata definition 32 for the custom tags 68, the gateway server 18 assigns a key ID 30 to the application 22 for identification, and stores the key ID 30 and the metadata definition 32 in a database 34 in step 206. In a preferred embodiment, the database 34 used to store the key IDs 30 is separate from the image database 20, although nothing precludes using the same database for both purposes.

The key ID 30 may be a 32 or 64-bit number that is unique for the application 22 being developed by the developer 28. For example, assume that a developer 28 created a camera application 22 for the insurance industry, where the application 22 is customized for different insurance companies. Assume further that each customized application 22 stores slightly different information in the customize tags 68 or that the customize tags 68 are to be displayed in a different format by each of the insurance companies. In this case, the developer 28 would enter a metadata definition 32 for each of the applications 22, and the gateway server 18 would assign a unique key ID 30 to each custom application 22. The key IDs 30 are not assigned according to the identity of the developer 28 or the company using the camera application 22 because a particular developer 28 may develop two different camera applications 22 for the same company, and the server 18 needs to distinguish between the image files 50 produced by the two different applications 22. However, for security reasons user accounts may be associated with the use a particular key ID.

After assigning the key ID 30 to the application 22, the gateway server 18 provides the key ID 30 to the developer in step 208. The key ID 30 may be provided to the developer by displaying the key ID 30 on a web page or by e-mailing key ID 30 to developer.

The developer 28 then programs the application 22 to store the key ID 30 and custom data into one or more of the custom tags 68 within the image files 50 when the application 22 is run on the camera 14 in step 210. If the application 22 is to operate in conjunction with an external device connected to the camera 14 or a separately generated data file, then the developer must also program the application to receive data from the external device or the data file placed on the cameras flash disk, and to store the data into specified custom tags 68. Data may be provided by the user by selecting from a menu, or entering the data using a text entry software or hardware approach. The data may be preloaded into the application via a data file, which resides either in the camera or on the server under the user's account. This data file may provide an ordered collection of image data, or may be used to provide a menu selection for the user, thus avoiding the requirement of typing and a lot of data, which is a difficult effort without a hardware keyboard.

Images may be captured under the direction of the application, or the application may be run after the images are captured. In either case the data are associated with the appropriate image, either with or without the help of the user. The tags data is stored in each image file before being transferred to the server. In an alternative embodiment, the tags are not stored in the image files but are transferred to the photo-service site 16 separately from the images. In this embodiment, the photo-service site 16 is responsible for maintaining the relationship between the tags and the images.

The gateway server 18 receives image files 50 and extracts the image data and the image tags and stores them in the respective databases 20 and 34 in step 214. The metadata tags may be extracted and placed in the database 34 when the images are received or when images are viewed (real-time metadata extraction). In a preferred embodiment, the image data 54 and the image tags 60 are indexed by a user ID that is uploaded along with the image files 50.

After the images have been uploaded to the gateway server 18, the user may then log onto the gateway server 18 using an ID/password and make a request to view the uploaded images in step 216. In response, the gateway server 18 retrieves the images and the image tags 60 based on the user ID in step 218. The key ID 30 is then extracted from the user tags 66 and is used to retrieve the corresponding metadata definition 32 for the custom tags 68 in step 220. The gateway server 18 then dynamically builds and displays web pages containing the retrieved images and their custom tags 68 based on the retrieved metadata definition 32 in step 222. The gateway server 18 may also take any actions specified in the metadata definition 32 with respect to the custom tags 68. In an alternative embodiment, the server 18 creates the web pages containing the images and the custom tags 68 upon receipt of the uploaded image files 50, rather than when a request is made to view the images.

Referring again to FIG. 3, in one embodiment the user tags 66 are character strings of a fixed length, e.g., 32 characters. The developer 28, however, may need to create an application 22 that inserts data into the tags that exceed the fixed length. One solution to this problem is for the developer 28 to create the application such that it writes a piece of data into more than one of the tags 66. Another solution is to program the camera 14 to create image files 50 having additional tags (e.g., adding two 256 character tags). Although these methods may solve the problem, the methods are cumbersome to implement and do not serve well as long-term solutions.

According to a second aspect of the present invention, a set of tags is provided in the image files 50 whose sizes can be defined dynamically in the camera 14 by the camera application 22. The developer 28 defines the tags on the gateway server 18 for later recognition by the server 18, as described above, but the camera 14 is provided with an application programming interface that is used by the application 22 to inform the operating system of the names of the custom tags 68, the data type of the tags, and the sizes of the tags. When the camera 14 captures images under control the application 22, image files are created with the new tags having the specified sizes.

The use of the metadata Internet platform 10 will now be explained further by way of example. Assume there is a user 24 named Harry who wants to allow photo inventories on his website. Harry writes a script, which when run on the camera 14 allows a user to take a picture of the item to be inventoried, and then requests information for that item: value, description, and location. Harry then goes to the gateway server 18 website where he has registered as a script developer, and clicks on a link “Create a Presentation Format Using Metadata.” This brings him to a set of forms where he can define which user and custom tags he is using, what their labels are, and how their contents should be displayed. He can also indicate which system tags 64 are to be displayed.

Harry decides to use a tag called User Data 1 (udt1) to store the value entered by the user, User String 1 and 2 (ust1, ust2) to store the description (up to 64 characters), and User String 3 (ust3) to store the location. Harry also decides to show date and time of capture, zoom and focus distance. He enters the following information in a series of steps via web forms displayed by the gateway server 18:

udt1: integer formatted as currency, zero decimal places, with commas, label=“Item Value”

ust1, ust2 pair: text, label=“Item Description”

udt3: text, label=“Item Location”

fdst: label=“Item Distance”

zpos: label=“Zoom Setting”

time: (default label is OK)

date: (default label is OK)

The data is entered in the order Harry wants it listed. A form is provided to reorder the data, if after entering it, Harry realizes that a different order would be better. After completing the specification, the gateway server 18 provides him with a key ID number. Harry programs his script to store this key ID number in image files 50 in a tag called User Tag (utag).

Once Harry has his inventory script working, he offers it for free on his website. Camera owner can now download the script to create a home or business photo inventory using their digital cameras 14. When images created with the script are uploaded to the gateway server 18 with the assigned key ID in utag, the gateway server 18 retrieves the corresponding metadata definition and uses it to automatically extract the data in the specified tags and display them along with the image.

Assume further that developer A has created an application for the insurance industry that allows agents to take a picture of a car and using a bar-code reader attached to the camera 14, reads the vehicle identification number (VIN) from the car and inserts to into one of the user tags 66 in the image file. As described above, the developer A logs onto the gateway server 18 and provides the metadata definition 32 for the new VIN tag of the insurance application. Once the images are uploaded to the gateway server 18, the metadata definition 32 allows the gateway server 18 to automatically recognize and extract the VIN from the image files 50 and display the VINs in a web page next to the car images. The metadata definition 32 may also instruct the gateway server 18 to store the VINs in a database.

Thus, the metadata Internet platform 10 provides both Harry and developer A with a system that can recognize images from cameras running different camera applications, which eliminates the need for them to have to write their own PC or web application that can read the image files, saving developing time and costs.

An Internet platform for customizing metadata in digital images has been disclosed. Although the present invention has been described in accordance with the embodiments shown, one of ordinary skill in the art will readily recognize that there could be variations to the embodiments and those variations would be within the spirit and scope of the present invention. For example, in the embodiment where the photo-service includes more than one server, the function of gateway server may be to establish communications with the device, uploaded information, and pass the information off to a photo hosting/sharing server. A photo sharing/hosting server would preferably have the metadata definition of the tags and would perform the recognition/extraction function. The reason for this is that the tags should stay “with” the image, and the definition should be where the images are a viewed, which is the photo hosting/sharing portion of the total system. Accordingly, many modifications may be made by one of ordinary skill in the art without departing from the spirit and scope of the appended claims.

What is claimed is:

1 A method for customizing tags in digital images captured with an image capture device that stores the digital images in image files, the method comprising the steps of:
(a) storing a key ID and a definition of one or more custom tags on a server on a network;
(b) receiving a plurality of image files over the network, wherein each of the image files includes image data, the key ID, and the custom tags containing data; and
(c) automatically recognizing the image files by the key ID and using the stored definition to extract the data from the custom tags to make the data available to a user along with the image data.

2 The method of claim 1 wherein step (a) further includes the step of:
(i) receiving the definition of the custom tags from a developer over the network.

3 The method of claim 2 wherein step (a) further includes the step of:
(ii) assigning the key ID in response to receiving the definition of the custom tags to enable the developer to incorporate the key ID and the custom tags into a camera application that is to be run on the digital camera for generating the image files.

4 The method of claim 3 wherein step (b) further includes the step of:
(i) extracting the image data and the custom tags from each image file and storing the image data and custom tags in at least one database.

5 The method of claim 4 wherein step (c) further includes the step of:
(i) allowing a user to log onto the gateway server using a user ID to make a request to view the uploaded images.

6 The method of claim 5 wherein step (c) further includes the steps of:
(ii) in response to the user logging in, retrieving the image data and the custom tags using the user ID,
(iii) using the key ID to retrieve the definition of the custom tags, and
(iv) dynamically building and displaying web pages containing the retrieved image data and their custom tags based on the retrieved definition and taking any actions specified in the definition with respect to the custom tags.

7 The method of claim 1 wherein step (b) further includes the step of:
(i) extracting the custom tags from the image files when image files are received.

8 The method of claim 1 wherein step (c) further includes the step of:
(i) extracting the custom tags from the image files when image files are viewed.

9 The method of claim 1 wherein step (b) further includes the step of:
(i) receiving the custom tags separately from the image files.

10 A computer-readable medium containing program instructions for customizing tags in digital images captured with an image capture device that stores the digital images in image files, the program instructions for:
(a) storing a key ID and a definition of one or more custom tags on a server on a network;
(b) receiving a plurality of image files over the network, wherein each of the image files includes image data, the key ID, and the custom tags containing data; and
(c) automatically recognizing the image files by the key ID and using the stored definition to extract the data from the custom tags to make the data available to a user along with the image data.

11 The computer-readable medium of claim 10 wherein instruction (a) further includes the instruction of:
(i) receiving the definition of the custom tags from a developer over the network.

12 The computer-readable medium of claim 11 wherein instruction (a) further includes the instruction of:
(iii) assigning the key ID in response to receiving the definition of the custom tags to enable the developer to incorporate the key ID and the custom tags into a camera application that is to be run on the digital camera for generating the image files.

13 The computer-readable medium of claim 12 wherein instruction (b) further includes the instruction of:
(i) extracting the image data and the custom tags from each image file and storing the image data and custom tags in at least one database.

14 The computer-readable medium of claim 13 wherein instruction (c) further includes the instruction of:
(i) allowing a user to log onto a server using a user ID to make a request to view the uploaded images.

15 The computer-readable medium of claim 14 wherein instruction (c) further includes the instructions of:
(ii) in response to the user logging in, retrieving the image data and the custom tags using the user ID,
(iii) using the key ID to retrieve the definition of the custom tags, and
(iv) dynamically building and displaying web pages containing the retrieved image data and their custom tags based on the retrieved definition and taking any actions specified in the definition with respect to the custom tags.

16 A system for customizing tags in image files produced by a software-controlled image capture device, comprising:
a photo-service site on a network for receiving digital images from the image capture device, photo-service site including
means for storing a key ID and a definition of one or more custom tags;
means for receiving a plurality of image files over the network, wherein each of the image files includes image data, the key ID, and the custom tags containing data; and
means for automatically recognizing the image files by the key ID and using the stored definition to extract the data from the custom tags to make the data available to a user along with the image data.

17 The system of claim 16 wherein the receiving means receives the definition of the custom tags from a developer over the network.

18 The system of claim 17 wherein the photo-service site assigns the key ID in response to receiving the definition of the custom tags to enable the developer to incorporate the key ID and the custom tags into a camera application that is to be run on the digital camera for generating the image files.

19 The system of claim 18 wherein the image data and the custom tags are extracted from each image file upon receipt and stored in at least one database.

20 The system of claim 19 the photo-service site using a user ID and to make a request to view the uploaded images.

21 The system of claim 20 wherein the photo-service site further includes
means for retrieving the image data and the custom tags using the user ID in response to the user logging in,
means for using the key ID to retrieve the definition of the custom tags, and
means for dynamically building and displaying web pages containing the retrieved image data and their custom tags based on the retrieved definition and taking any actions specified in the definition with respect to the custom tags.

22 The system of claim 16 wherein the custom tags are extracted from the image files when image files are received.

23 The system of claim 16 wherein the custom tags are extracted from the image files when image files are viewed.

24 The system of claim 16 wherein the custom tags are received separately from the image files.

25 A method for customizing metadata tags in digital images captured with an image capture device that stores the digital images in image files, the method comprising the steps of:
(a) receiving a metadata definition of custom tags from a developer over the network;
(b) associating a key ID with the metadata definition;
(c) providing the key ID to the developer so that the developer can program a camera application to store data and the key ID into the custom tags of image files on the digital camera;
(d) receiving a plurality of image files over the network, wherein each of the image files includes image data, the key ID, and the custom tags containing data; and
(e) automatically recognizing the image files by the key ID and using the metadata definition associated with the key ID to extract the data from the custom tags to make the data available to a user along with the image data.

26 The method of claim 25 wherein step (a) further includes the step of allowing the developer to included instructions in the metadata definitions for how the data in the custom tags should be displayed.

27 The method of claim 26 further including the step of providing the image files with user tags for storing user settable data.

28 The method of claim 27 further including the step of providing the custom tags as part of the user tags.

29 The method of claim 28 further including the step of providing the image files with system tags for storing camera information.

30 The method of claim 29 wherein step (d) further includes the step of:
(i) extracting the image data and the custom tags from each image file and storing the image data and custom tags in at least one database.

31 The method of claim 30 wherein step (d) further includes the step of:
(iii) allowing a user to log onto a server using a user ID to make a request to view the image data from the uploaded image files.

32 The method of claim 31 wherein step (e) further includes the steps of:
(i) in response to the user logging in, retrieving the image data and the custom tags using the user ID,
(ii) using the key ID to retrieve the metadata definition of the custom tags, and
(iii) dynamically building and displaying web pages containing the retrieved image data and their custom tags based on the retrieved definition and taking any actions specified in the definition with respect to the custom tags.
